(19) United States
(12) Patent Application Publication
(10) Pub. No.: US 2017/0132545 A1
(43) Pub. Date: May 11, 2017

(54) RECENCY-BASED IDENTIFICATION OF AREA PATHS FOR TARGET COMPONENTS

(71) Applicant: MICROSOFT TECHNOLOGY LICENSING, LLC, Redmond, WA (US)

(72) Inventors: Nir Michaely, Redmond, WA (US); Amit Gala, Bothell, WA (US); Cherno Waka Jagne, Bothell, WA (US); Dazhi Zhang, Bellevue, WA (US); Joseph Wesley Sullivan, Lynnwood, WA (US); Naveen Sethuraman Nair, Bothell, WA (US); Shiva S. Nimmagadda Venkata, Redmond, WA (US); Somu Jayabalan, Redmond, WA (US)

(21) Appl. No.: 14/938,254

(22) Filed: Nov. 11, 2015

(51) Int. Cl. G06Q 10/06

(52) U.S. Cl. CPC G06Q 10/06313

(57) ABSTRACT

Technologies for reliably and efficiently mapping any particular bug report identifying a target component to a relevant owner who is currently responsible for handling the bug report. This mapping involves considering a list of developers that have historically and currently contributed to the identified target component, ranking each contributing developer based on a measure of recency of his contribution, considering a list of the managers of the contributing developers, ranking each manager based on the rankings of his contributing developers, identifying an area path (“AP”) in an AP hierarchy based on these rankings, mapping the identified AP to a current AP, determining, based on the current AP, a relevant owner of the identified target component, and assigning the bug report to the relevant owner. Further, the various lists and AP hierarchy metadata need not be centrally updated; instead, crowd sourcing techniques are employed that promote updating of the lists and AP hierarchy metadata based on social pressure to ensure the most relevant owner is ultimately assigned the bug report.

### BACKGROUND

Computer software has become common and even essential modern society. Some of this software is quite complex and may involve hundreds, thousands, and even tens-of-thousands of engineers, developers, testers, managers, and other support personnel to create, update, and maintain. Once such software is delivered to users, perhaps to thousands and millions of users, bugs are inevitably discovered.

In order to address the bugs that are discovered, various forms of reports are created (often automatically) and provided to the developer (e.g., a company) of the software. Such a bug report may identify the particular file and path (i.e., target file) that exhibited the bug (e.g., threw an exception) along with additional information describing the bug. Such information may include code traces, system dumps, and/or any other kind of relevant information that may help in identifying and fixing the bug. But the target fail to which the bug report applies may be one of many files, perhaps one of tens-of-thousands of files.

For example, an operating system or a word processor may comprise many thousands of files that were developed over many years by many different people. These people tend to come and go, to move around within the developing organization, within the various teams in the organization, and they even leave the organization and go elsewhere. Thus, when a bug report directed to a particular target file arrives, it can be quite difficult to determine the right individual to handle the bug report. This common situation can make it difficult for developers of software to timely address problems with the software they develop.

### SUMMARY

The summary provided in this section summarizes one or more partial or complete example embodiments of the invention in order to provide a basic high-level understanding to the reader. This summary is not an extensive description of the invention and it may not identify key elements or aspects of the invention, or delineate the scope of the invention. Its sole purpose is to present various aspects of the invention in a simplified form as a prelude to the detailed description provided below.

The invention encompasses technologies for reliably and efficiently mapping any particular bug report identifying a target component to a relevant owner who is currently responsible for handling the bug report. This mapping involves considering a list of developers that have historically and currently contributed to the identified target component, ranking each contributing developer based on a measure of recency of his contribution, considering a list of the managers of the contributing developers, ranking each manager based on the rankings of his contributing developers, identifying an area path (“AP”) in an AP hierarchy based on these rankings, mapping the identified AP to a current AP, determining, based on the current AP, a relevant owner of the identified target component, and assigning the bug report to the relevant owner. Further, the various lists and AP hierarchy metadata need not be centrally updated; instead, crowd sourcing techniques are employed that promote updating of the lists and AP hierarchy metadata based on social pressure to ensure the most relevant owner is ultimately assigned the bug report.

Many of the attendant features will be more readily appreciated as the same become better understood by reference to the detailed description provided below in connect on with the accompanying drawings.

### DESCRIPTION OF THE DRAWINGS

The detailed description provided below will be better understood when considered in connection with the accompanying drawings, where:

FIG. 1 is a block diagram showing an example computing environment in which the invention described herein may be implemented.

FIG. 2 is a block diagram showing an example system 200 configured for mapping any particular bug report that identifies a target component to a particular team and to a relevant owner responsible for handling the bug report (e.g., resolving the bug).

FIG. 3 is a block diagram showing an example owner tracker 212, a component of system 200 that is configured for identifying relevant owners responsible for target components.

FIG. 4 is a block diagram showing an example method 400 for mapping any particular bug report for a particular target component to a relevant owner who is responsible for handling the bug report.

FIG. 5 is a block diagram showing an example method 500 for determining, in a particular AP hierarchy structure, a particular area path (“AP”) that corresponds to an identified target component.

FIG. 5 is a block diagram showing an example method 600 for calculating a calculated benchmark ranking (“CBR”) for a particular contributor to a identified target component.

FIG. 7 is a block diagram showing an example method 700 for calculating a manager calculated benchmark ranking (“MCBR”) for a particular manager relative to a identified target component, the particular manager such as from a manager list (such as retrieved at block 512 of FIG. 5).

FIG. 8 is a block diagram showing an example simplified hierarchical structure of an example source tree maintained in an example code database such as code database 260.

FIG. 9 is a block diagram showing an example method 900 for building a list of contributors to a source file that is the subject of a bug report, as well as building a list of the managers of the contributors.

FIG. 10 is a block diagram showing an example method 1000 for determining a relevant owner and team that corresponds to an identified target component.

Like-numbered labels n different figures are used to designate similar or identical elements or steps in the accompanying drawings.

### DETAILED DESCRIPTION

The detailed description provided in this section, in connection with the accompanying drawings, describes one or more partial or complete example embodiments of the invention, but is not intended to describe all possible embodiments of the invention. This detailed description sets forth various examples of at least some of the technologies, systems, and/or methods invention. However, the same or equivalent technologies, systems, and/or methods may be realized according to examples as well.

Although the examples provided herein are described and illustrated as being implementable in a computing environment, the environment described is provided only as an example and not a limitation. As those skilled in the art will appreciate, the examples disclosed are suitable for implementation in a wide variety of different computing environments.

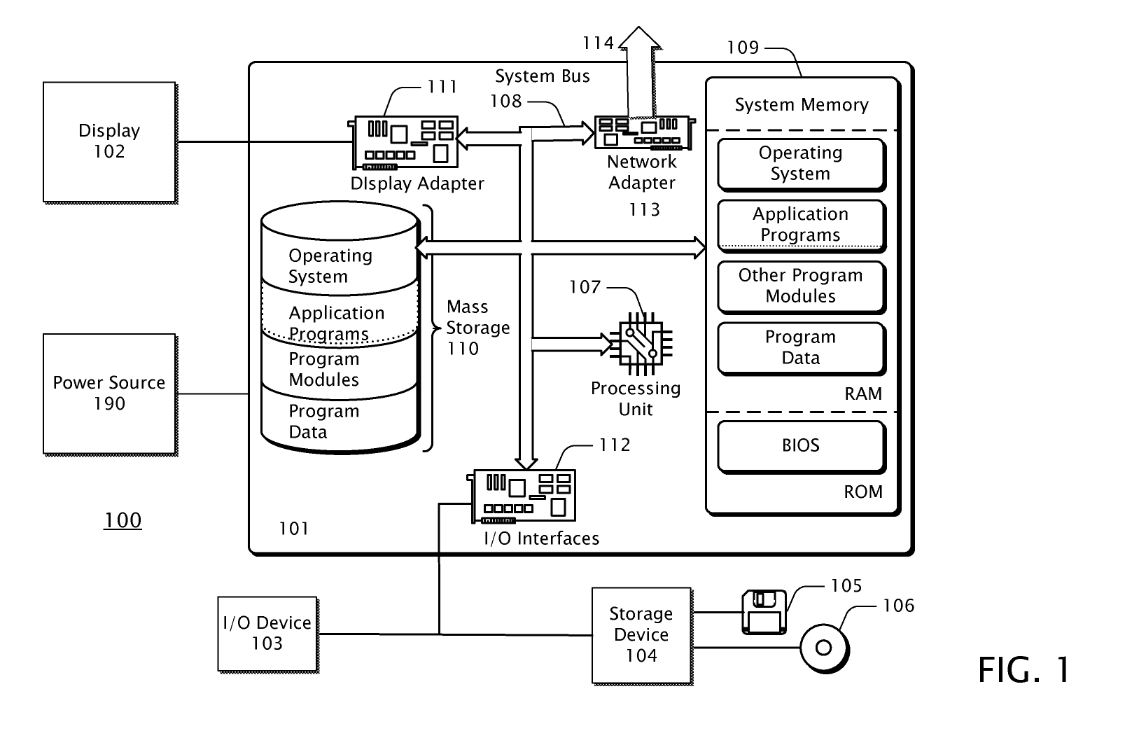

FIG. 1 is a block diagram showing an example computing environment 100 in which the invention described herein may be implemented. A suitable computing environment may be implemented with numerous general purpose or special purpose systems. Examples of well-known systems include, but are not limited to, cell phones, personal digital assistants (“PDA”), personal computers (“PC”), hand-held or laptop devices, microprocessor-based systems, multiprocessor systems, systems on a chip (“SOC”), servers, Internet services, workstations. consumer electronic devices, cell phones, set-top boxes, and the like. In all cases, such systems are strictly limited to articles of manufacture and the like.

Computing environment 100 typically includes a general-purpose computing system in the form of a computing device 101 coupled to various components, such as peripheral devices 102, 103, 101 and the like. These may include components such as input devices 103, including voice recognition technologies, touch pads, buttons, keyboards and/or pointing devices, such as a mouse or trackball, that may operate via one or more input/output (“I/O”) interfaces 112. The components of computing device 101 may include one or more processors (including central processing units (“CPU”), graphics processing units (“GPU”), microprocessors (“μP”), and the like) 107, system memory 109, and a system bus 108 that typically couples the various components. Processor(s) 107 typically processes or executes various computer-executable instructions and, based on those instructions, controls the operation of computing device 101. This may include the computing device 101 communicating with other electronic and/or computing devices, systems or environments (not shown) via various communications technologies such as a network connection 114 or the like. System bus 108 represents any number of bus structures, including a memory bus or memory controller, a peripheral bus, a serial bus, an accelerated graphics port, a processor or local bus using any of a variety of bus architectures, and the like.

System memory 109 may include computer-readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 109 typically stores data, computer-executable instructions and/or program modules comprising computer-executable instructions that are immediately accessible to and/or presently operated on by one or more of the processors 107.

Mass storage devices 104 and 110 may be coupled to computing device 101 or incorporated into computing device 101 via coupling to the system bus. Such mass storage devices 104 and 110 may include non-volatile RAM, a magnetic disk drive which reads from and/or writes to a removable, non-volatile magnetic disk (e.g., a “floppy disk”) 105, and/or an optical disk drive that reads from and/or writes to a non-volatile optical disk such as a CD ROM, DVD ROM 106. Alternatively, a mass storage device, such as hard disk 110, may include non-removable storage medium. Other mass storage devices may include memory cards, memory sticks, tape storage devices, and the like.

Any number of computer programs, files, data structures, and the like may be stored in mass storage 110, other storage devices 104, 105, 106 and system memory 109 (typically limited by available space) including, by way of example and not limitation, operating systems, application programs, data files, directory structures, computer-executable instructions, and the like.

Output components or devices, such as display device 102, may be coupled to computing device 101, typically via an interface such as a display adapter 111. Output device 102 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 101 to interact with human operators or other machines, systems, computing environments, or the like. A user may interface with computing environment 100 via any number of different I/O devices 103 such as a touch pad, buttons, keyboard, mouse, joystick, game pad, data port, and the like. These and other I/O devices may be coupled to processor 107 via I/O interfaces 112 which may be coupled to system bus 108, and/or may be coupled by other interfaces and bus structures, such as a parallel port, game port, universal serial bus (“USB”), fire wire, infrared (“IR”) port, and the like.

Computing device 101 may operate in a networked environment via communications connections to one or more remote computing devices through one or more cellular networks, wireless networks, local area networks (“LAN”), wide area networks (“WAN”), storage area networks (“SAN”), the Internet, radio links, optical links and the like. Computing device 101 may be coupled to a network via network adapter 113 or the like, or, alternatively, via a modem, digital subscriber line (“DSL”) link, integrated services digital network (“ISDN”) link, Internet link, wireless link, or the like.

Communications connection 114, such as a network connection, typically provides a coupling to communications media, such as a network. Communications media typically provide computer-readable and computer-executable instructions, data structures, files, program modules and other data using a modulated data sig such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 190, such as a battery or a power supply, typically provides power for portions or all of computing environment 100. In the case of the computing environment 100 being a mobile device or portable device or the like, power source 190 may be a battery. Alternatively, in the case computing environment 100 is a desktop computer or server or the like, power source 190 may be a power supply designed to connect to an alternating current (“AC”) source, such as via a wall outlet.

Some mobile devices may not include r any of the components described in connection with FIG. 1. For example, an electronic badge may be comprised of a coil of wire along with a simple processing unit 107 or the like, the coil configured to act as power source 190 when in proximity to a card reader device or the like. Such a coil may also be configure to act as an antenna coupled to the processing unit 107 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 102, I/O device 103, or many of the other components described in connection with FIG. 1. Other mobile devices that may not include many of the components described in connection with FIG. 1, by way of example and not limitation include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may he carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, program modules, or the like maintained in an electronic memory such as a ROM that is embedded in an electronic device. The term “software” generally refers to computer-executable instructions, code, data, applications, programs, program modules, or the like that are maintained in or on any form or type of computer-readable media that is configured for storing computer-executable instructions or the like in a manner that is accessible to a computing device. The terms “computer-readable media” and “computer-readable media” and the like as used herein are strictly limited to being one or more apparatus, article of manufacture, or the like that is statutory hardware and that is not a signal or carrier wave per se. The term “computing device” as used in the claims refers to one or more hardware devices such as computing device 101 and encompasses client devices, mobile devices, one or more servers, network services such as an Internet service or corporate network service, and the like, and any combination of such.

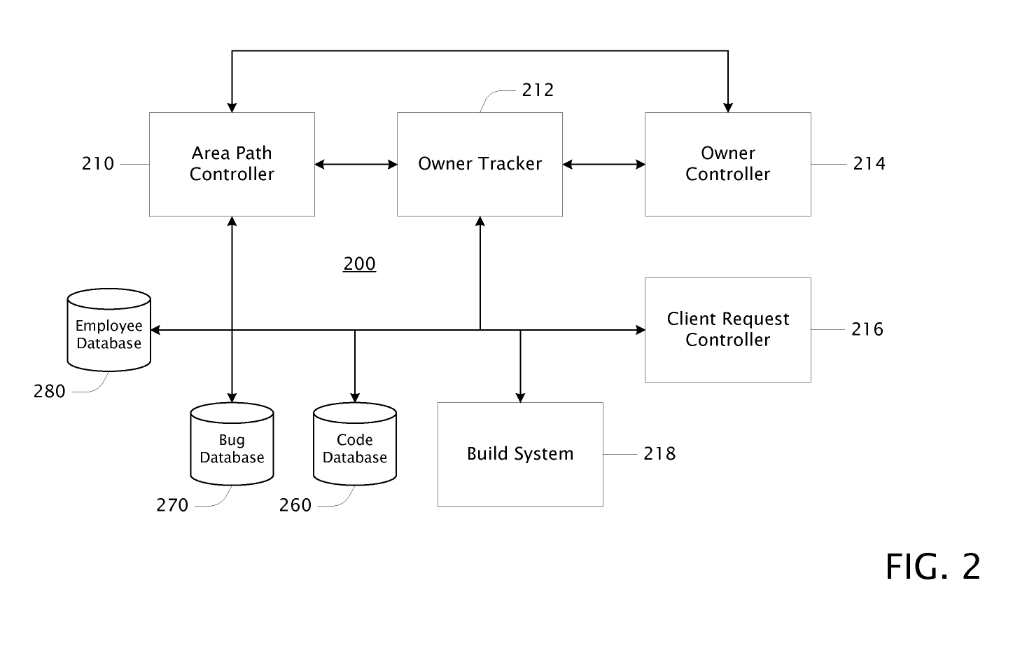

FIG. 2 is a block diagram showing an example system 200 configured for mapping any particular bug report that identifies a target component to a particular team and to a relevant owner responsible for handling the bug report (e.g., resolving the bug). In one example, the relevant owner is the person to whom system 200 should assign the bug report. A bug report typically includes at least the following information:
ID: a unique identifier for this bug report in a particular bug database;
Target: an identification of the target component that is the subject of the bug report;
Team: an identification of the team or the like responsible for the identified target component; and
AssignedTo: an identification of the person or placeholder (e.g., the relevant owner) the bug report is assigned to.

Bug reports may include other fields and/or information as well, such as some form of description of the problem related to the target component, some form of description of the machine or the like comprising the target component, and any other information and/or attachments relevant to the bug report, the problem, the target component, etc.

System 200 typically includes several components including area path controller 210, owner tracker 212, owner controller 214, client request controller 216, build system 218, code database 260, bug database 270, and employee database 280. Each of these components (including any sub-components) may be implemented as a system comprising a hardware logic device (e.g., an integrated circuit a device comprising such circuits), a computing device (such as described in connection with FIG. 1 or the like) that executes instructions to perform the requisite method(s), a service comprising a set of devices (including one or more such as described in connection with FIG. 1 or the like), or as some combination of the foregoing. Each such component may be implemented on/by one device, such as a hardware logic device or computing device, or across multiple such devices. For example, a component may be implemented in a distributed fashion on/by multiple devices such as, for example, servers or elements of a network service or web site or the like. Further, each such component (including any sub-components) may encompass one or more sub-components or the like, and the components may be implemented as separate components, or any two or more may be combined in whole or in part. The division of components described herein is non-limiting except where indicated, and is intended primarily to aid in describing aspects of the invention.

In one example, system 200 is configured for mapping any particular bug report for an identified target component to a relevant owner who is responsible for handling the bug report. This mapping involves an incoming or pre-existing bug report. Such a bug report could pre-exist in a bug database such as bug database 270 or could originate from any client, where the term “client” indicates a user of some code or product for which a problem or bug is being reported. Such a user may be a person(s), such as a test engineer, or a system(s), such as an automated test or evaluation system. For example, a security analysis system may automatically evaluate source files to identify security issues in the code of the source files, and report the discovered issues in the form of bug reports. Such systems (clients) may generate thousands of bug reports in a relatively short time depending on the amount of source code being evaluated.

A client may be external or internal to the “developing organization”, a term that indicates the entity(s), organization(s), and/or individual(s) that are developing or have developed the code or product for which the problem is reported. The term “bug report” as used herein indicates a report of the problem with the code or product as experienced by the client. The term “relevant owner” as used herein refers to a particular person to whom a particular bug report is to be assigned as determined by system 200. This person could be a developer, a tester, a program manager, a triage specialist; or a team lead such as a development lead, a test lead, a program manager (“PM”) lead, or a triage lead; or a manager; or any other appropriate person. The terms “team” and “group” and the like refer to units and sub-units of a hierarchical organization structure. While in some cases groups may be described as comprising teams, no particular ordered relationship is required except where explicitly stated otherwise.

In one example, a bug report comprises information about the problem that includes an identification of a “target component”, a term that indicates the component that surfaced or exhibited the problem or bug such as, for example, an executable file that threw an exception or otherwise exhibited a problem during execution or the like. Such bug reports are typically received directly or indirectly from various clients or pre-exist n a bug database such as bug database 270.

In one example, the target component may be a single executable file that is a component of a product that is comprised on hundreds, thousands or even tens-of-thousands of such files. The term “product” as used herein refers to computer operating systems, word processors, spreadsheets, database systems, email systems, web applications, imbedded code and logic, computing devices, and any of an infinite variety of other software, firmware, or hardware products, and any combination thereof. Such a target component may currently be in the process of development or it may have been released for more general usage in a prototype or beta form or in a final form. Thus, such a target component may be considered incomplete or complete and, if complete, may have been deemed complete and released for more general usage in the recent past, many years ago, or at any time in-between.

In one example, a target component is a file that is identified by its filename and perhaps by a product that it is a part of or associated with. Such a file may be a binary file or an executable file. In another example, a target component is a file that is uniquely identified in the context of a product by its filename or a combination of its installed pathname and filename. For example, the filename of the target component may be foo.exe and the installed pathname of the target component may be “\ProductX\feature1”. In a first example, the filename foo.exe may be unique across a product (e.g., ProductX). In a second example, there may be other components with the same filename as foo.exe located in other directories or folders of the product. In the second example, the pathname-plus-filename (e.g., “\product\feature1\foo.exe”) uniquely identifies the target component in the context of the product. A unique filename and a combination of pathname-plus-filename are examples of unique identification of a target component in the context of the product of which they are a part. Other means of unique identification may alternatively or additionally be used, such as global unique identifiers (“GUIDs”) assigned to target components, unique serial numbers of target components, unique signatures of target components, or the like, so long as the end result is unique identification of the various target components of a product.

One challenge addressed by system 200 in mapping a bug report for a target component to a relevant owner is that the target component may have been released many years previous to the bug report and/or there may be many potential owners for the bug report simply due to the amount of time that has past. Indeed, the individual that owned the target component at the time of development may no longer work on the same component, or in the group currently responsible for the component, or on the product of which the target component is a part, or even in the same company, or may no longer work at all. For example, a product company may have over 40,000 individuals involved in product development, and a particular product group within that company may have over 10,000 individuals involved in the development of a particular product(s). Such a group may be responsible for over s million source files that are used to build such products.

Individuals in organizations like those in the examples above commonly move around within and between product groups all the time, particularly after a product ships. This in addition to individuals joining and leaving the company. Thus, given over 10,000 individuals and over six million source files for example, reliably and efficiently in mapping a particular bug report for one target component to a single relevant owner can be quite challenging. System 200 addresses these complex and vexing issues by reliably and efficiently mapping any particular bug report for an identified target component to a relevant owner who is currently responsible for handling the bug report. By so doing, system 200 improves the art of product development (software development in particular), reduces the costs and complexity of bug report assignment and owner tracking, and reduces the need for centralized management of the various data required for such assignment and owner tracking. Given that the testing and debugging of products generally make up a significant percentage of product development costs, even 50% or more in many cases, and that such testing and debugging relies on proper bug report assignment, such improvements to the art are significant indeed.

Bug database 270 may be a component of system 200 or may be a separate and/or pre-existing component of a product development environment that is utilized by system 200. In one example, bug database 270 is a separate and/or pre-existing component. Such a bug database typically stores bug reports along with their current status. The stored bug reports typically include newly-entered or current bur reports (open bug reports) as well as reports for bugs that have been resolved (closed bug reports). Closed bug reports may provide useful historical information for system 200. In one example, bug database 270 maintains current and historical bug reports for current, in-development, and previous versions of one or more products and their respective components. Such current and historical bug report information is typically accessed by system 200 to facilitate the mapping of bug reports for target components to relevant owners.

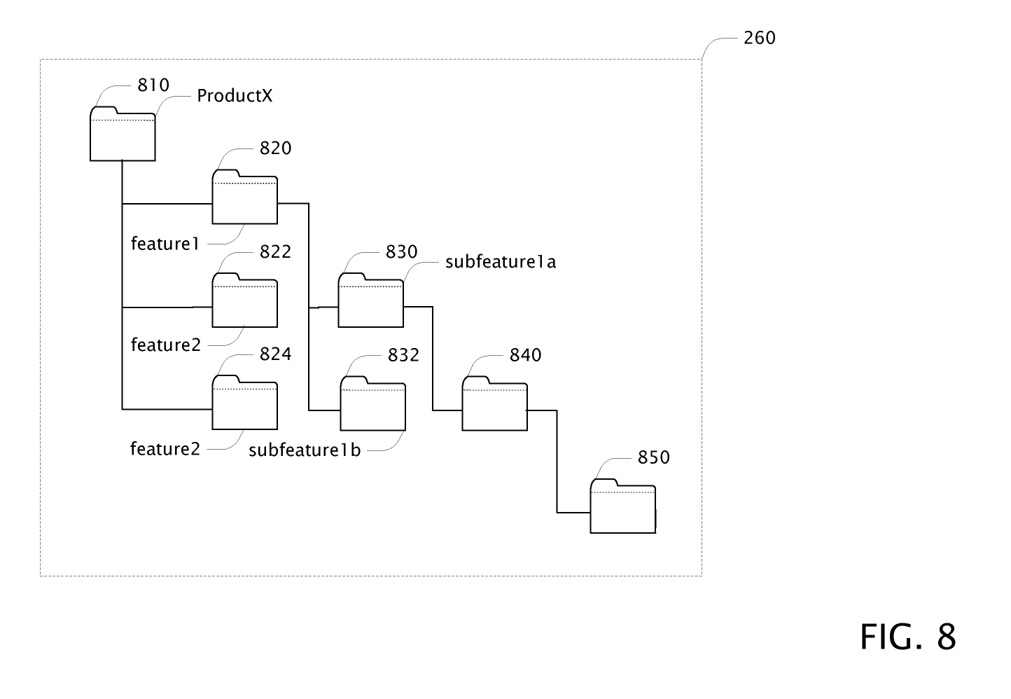

Code database 260 may be a component of system 200 or may be a separate and/or pre-existing component of a product development environment that is utilized by system 200. In one example, code database 260 is a separate and/or pre-existing component. Such a code database, also known as a source tree(s), typically stores source files. The term “source file” as used herein refers to any file used in building a firmware or software product or the like. Source files are typically compiled and/or otherwise assembled or combined into products or portions of products by a build system(s) such as build system 218 or the like, or they provide instructions or information used in such compiling, assembling, and/or combining. Such code databases may be organized in the form of a tree structure(s)—hence the name “source tree”—where the source files for a particular product or version of a product are organized in a tree structure. Such a tree structure, like a file system, generally comprises a hierarchy of folders/directories that comprise source files and the like. In one example, for a particular version of ProductX, all of the source files used to create ProductX are organized and stored under a ProductX root directory or the like (e.g., se FIG. 8). The ProductX root directory may include source files deemed general to the entire product as well as subdirectories for various features, components, or other divisions of ProductX. Each such subdirectory may contain source files and/or additional subdirectories. Such nesting in a tree structure(s) may continue as desired for additional sub-features or the like. Code database 260 may include any number of source trees and/or may be comprised of any number of individual or sub code databases. Code database 260 may also include source code metadata relative to source trees, products, source files, or the like.

In one example, source code metadata stored in code database 260 typically includes, for each source file stored therein, an identification of the person (e.g., name, employee number, and/or some other identifier(s)) who checked a particular file into a particular source tree, the date and time of the check-in, how many lines of the source file were touched (i.e., modified, removed, and/or added), whether the touch involved adding, removing, and/or changing one or more lines in the source file (i.e., the “touch command”), and the date and time of each such touch, where a check-in may be considered a touch as well (e.g., a check-in is when all of the lines of code where initially added). Based on such source code metadata it is possible to view the entire “change history” of any source file in a source tree—that is, when the source file was originally added to the source tree and by whom along with every change (e.g., touch) ever made to the source file, to which specific lines of code (including new lines added), when each change was made, and by whom.

In a further example, the source code metadata stored in code database 260 typically includes, for each source file stored therein, an identification of each person that has contributed to each target component stored in code database 260. The metadata further, for each target component, indicates a number of and/or identifies the particular lines of code originally created as well as the lines of code later added, modified, deleted, fixed, and the like by each contributor, when such contributions were checked-in to the source tree of the database, etc. That is, the source code metadata identifies who changed a line of code, what line of code was changed and what the change was (e.g., an addition, deletion, or modification), when the line of code was changed (e.g., data and time), and where the change was made (e.g., identification of the particular source file with the changed line).

Employee database 280 may be a component of system 200 or may be a separate and/or pre-existing component of a product development environment that is utilized by system 200. In one example, employee database 280 is a separate and/or pre-existing component. Such an employee database typically stores current and historical employee information such as for a company or organization or the like that includes the product development environment. The term “employee” as used herein may include any person, paid or otherwise, involved with the company or organization as an employee, contractor, vendor, volunteer, or in any other capacity or status. The term “company” as used herein refers to any organization(s) or the like that has and employee(s) as defined herein responsible for addressing problems with target components.

Employee database 280 typically includes both current and historical employee information—that is, metadata regarding the employees. This employee metadata typically identifies each employee, their start and end dates with the company or organization, and their managers over time. In one example for fictitious X Corp, employee metadata for example employee Mary (as with all other employees) indicates the date she started and stopped working for X Corp, identification of her manager as of her start date, the team, group, division, and/or the like she was part at that time, etc. In addition, her employee metadata also includes information identifying the dates that she moved from one team or the like to another, her managers as they changed along with the dates of those changes. Thus, employee database 280 can be queried to discover identification and information about any employee at any point in time covered by database 280, the manager(s) of the employee, the teams and the like of the employee, and the dates of all changes in employee status, managers, teams and the like, etc.

Build system 218 may be a component of system 200 or may be a separate and/or pre-existing component of a product development environment that is utilized by system 200. In one example, build system 218 is a separate and/or pre-existing component. Such a build system typically accesses and utilizes source files in a code database such as code database 260 to build products or the like. In one example, build system 218 is a manual system that comprises a set of tools, conventions, and procedures used by “builders” (persons) to build products from source files. Such tools typically include compilers, assemblers, linkers, and the like. In another example, build system 218 is a fully-automated system that typically includes a similar set of tools and is configured to build products from source files without human intervention. In yet another example, build system 218 is a semi-automated system that includes a similar set of tools and is configured to build products from source files with human intervention by builders. As inputs, build system 218 typically accesses and utilizes source files from code database 260 or the like. As outputs, build system 218 typically produces executable files and other files that make up at least a part of a product(s) or the like. Build system 218 may also generate build metadata as part of the build process.

In one example, build metadata is embedded in the binary files built by build system 218. This embedded build metadata typically includes the source file(s) from which the binary file was built, and the locations of those source files in the source tree and identification of the source tree from which they were obtained for the building, Term “binary file” and “binary” as used herein refers to a file provided as output of build system 218. Such files may or may not be different than the source files used by build system 218 to build the output files. That is, some source files may be assembled, compiled, or otherwise modified in order to build an output file while other source files may simply be copied and possibly renamed as part of the build process. In general, build system 218 embeds build metadata into at least some of the files resulting from the build process. In an additional or alternative example, build system 218 stores the build metadata in a database(s) associated with build system 218.

Client request controller 216 may be a component of system 200 or may be a separate and/or pre-exist component of a product development environment that is utilized by system 200. In one example, client request controller 216 is a separate and/or pre-existing component. Such a client request controller typically receives bug reports directly or indirectly from various dents. Such receiving may be via an interface such as an application programming interface (“API”), a Web API (e.g., an API exposed via the Internet), a Web site or service, an email system, and/or any other interface, mechanism, or system. In one example, such a received bug report typically includes, or is processed by client request controller 216 to include, an identification of a target component. Further, receiving a bug report refers to the bug report itself in one example, or to an identification of a bug report in another example, where the identified bug report itself is stored elsewhere, such as in bug database 270 or with client request controller 216 or the like.

Further, client request controller 216 typically interacts with owner tracker 212 in order to request a relevant owner for a target component that is the subject of a bug report. In one example, this request involves providing an identification of the bug report and/or of the target component to owner tracker 212.

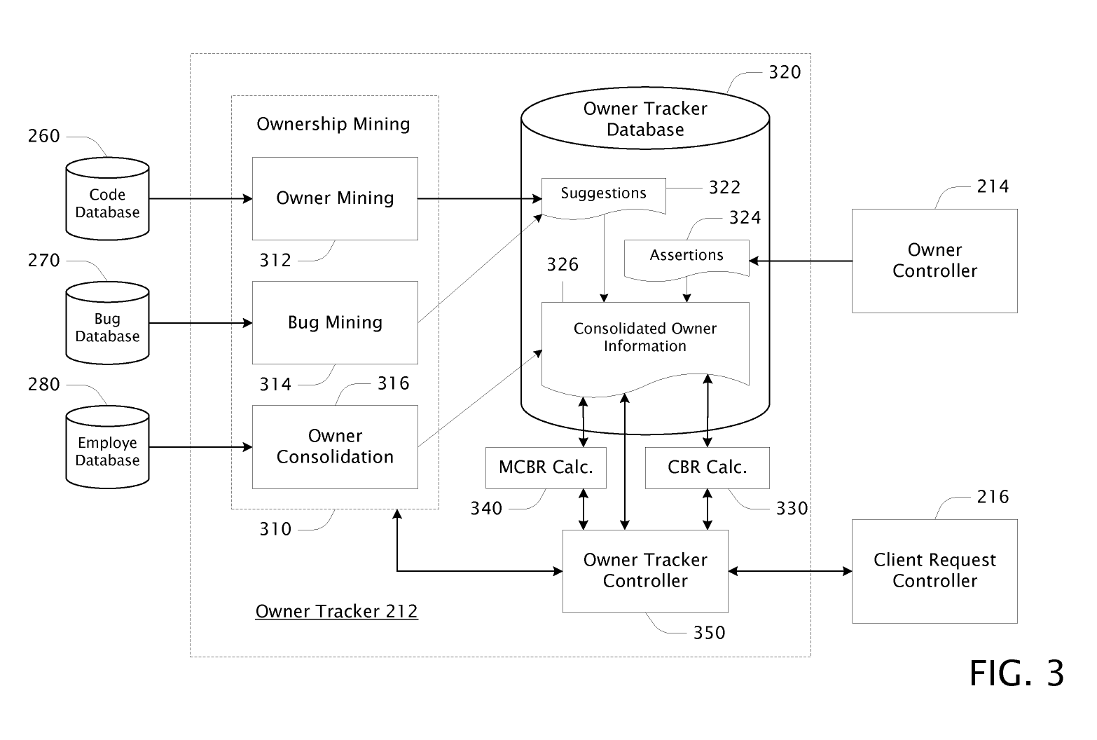

Owner tracker 212 of system 200 is a component that maps, based on information from the other components of system 200, a bug report for a target component to a relevant owner who is currently responsible for handling the bug. Owner tracker 212 is described in more detail in connection with FIG. 3.

Area path (“AP”) controller 210 may be a component of system 200 or may be a separate and/or pre-existing component of a product development environment that is utilized by system 200. In one example, AP controller 216 is a separate and/or pre-existing component. Such an AP controller typically manages hierarchical structures that represent products team organizations over time. Such AP hierarchical structures may be maintained in an AP database(s) (not shown). While APs themselves are not a primary focus of this disclosure, the following generalized explanation is provided to assist in understanding the relationship between APs and the other aspects of this disclosure.

For example, consider a fictitious product called ProductX. In this example, the development group for ProductX is part of Division X of X Corp. Thus, the hierarchical structure for ProductX can be represented as: X Corp→Division X→Product X Group. Each node of this structure is known as an “area path”. In addition to a representation of this structure, AP controller 210 also maintains AP metadata related to this structure. For example, for each AP node in a particular AP hierarchy, the AP metadata typically includes at least the following information:
ID: a unique identifier for this AP node in the AP hierarchy;
ParentID: a unique identifier for the parent node of this AP node in the AP hierarchy;
Name: the name of this AP;
Path: the full path of this AP node in the AP hierarchy;
Release: the release of the product to which this AP node corresponds;
Level: the level of this AP node in the AP hierarchy;
DevOwner: an identification of the development owner (e.g., dev lead) of this AP;
TestOwner: an identification of the test owner (e.g., test lead) of this AP;
PMOwner: an identification of the program manager owner (e.g., PM lead) of this AP;
TriageOwner: an identification of the triage owner (e.g., triage lead) of this AP;
ProjectName: the name of the project to which this AP corresponds; and
ProjectID: a unique identifier of the project to which this AP corresponds.

In addition, the AP metadata includes AP change description information that corresponds to changes to each AP, where such changes may include, for each AP, creating, merging, splitting, moving, modifying, and deleting. This AP change description information includes the date/time of each change as well as a description of the change, who made the change, etc. Note that the terms “AP” and “AP node” are used interchangeably. Note further that, particularly in the context of an AP hierarchy or hierarchical structure, an AP may also be referred to as an AP node, or a node of an AP hierarchy or hierarchical structure.

Given an AP hierarchical structure of AP nodes such as described above, and with access to employee metadata from an employee database(s) such as employee database 280, it is possible to identify the various owners in the Project X Group from Day 1, when they joined and left the group, their roles or titles and when they changed, their managers and direct reports and when they changed, etc. And we also know they were associated with Project X as they were in the Project X Group.

Now, at Day 100, let's say the research and design work is largely completed, so we create three new feature teams to implement ProjectX: the Client Team, the Server Team, and the Install Team. To reflect this change in product team organization, we add three new APs into the Project X Group hierarchical structure: (1) Client Team, (2) Server Team, and (3) Install Team, each added as peers under AP Project X Group. Further, we also update the AP metadata to reflect that some of the owners from Project X Group moved into the Client Team AP, some to Server Team, and some to Install Team. The AP metadata is updated to reflect the modified owners. For example, Jane Doe left Project X Group on Day 100 and joined Client Team on Day 100. Further, AP and employee metadata may be updated to reflect that Jane Doe's role in Client Team is development lead as of Day 120, for example. Similar updates may be made for the other owners involved. In addition, some people may leave the group altogether at or around Day 100, and other new people may join the group of one of the feature teams at some point in time as well. At this point in time, it is possible to identify the various owners in the Project X Group from Day 1, the owners in each of the feature teams from Day 100, who moved where and when, what feature team they worked on, when they joined and left the group or feature teams, their roles and when they changed, their managers and direct reports and when they changed, etc.

As indicated above, the AP metadata typically includes the following owner roles for each AP: (1) development owner—a person (e.g., a feature team development lead) responsible for development-related activities within a feature team or the like represented by the AP, (2) test owner—a person (e.g., a feature team test lead) responsible for test-related activities within the feature team, (3) program manager lead—a person (e.g., a feature team program manager (“PM”) lead) responsible for feature definition-related activities within the feature team, and (4) triage lead—a person (e.g., a feature team triage lead) responsible for overseeing bug fix activities within the feature team. The AP metadata is typically updated to reflect organizational changes related to Project X. In one example, such changes are made via owner controller 214. Such changes may be made by team leads and manager themselves or by their assigns, thus minimizing the need for centralized management of AP metadata.

Owner controller 214 may be a component of system 200 or may be a separate and/or pre-existing component of a product development environment that is utilized by system 200. In one example, owner controller 216 is a separate and/or pre-existing component. Such an owner controller typically enables users of system 200 to enter and update AP metadata, such as that associated with AP controller 210, and to enter and update owner tracker metadata, such as assertions 324 in owner tracker database 320. In one example, owner controller 214 is a crowd sourcing service that provides a web interface or the like that can be made available via a network(s) and/or the Internet to users of system 200. Such users typically include persons such as those listed in AP hierarchies and/or on product teams. In this manner, the various team leads and managers (or their assigns) are able to enter and update AP and owner tracker metadata at their convenience. As there may be thousands and even tens-of-thousands of persons listed in AP hierarchies and/or on product teams, the functionality of owner controller 214 enables those closest to the actual feature teams, those directly responsible for the various feature teams, to maintain the AP and owner tracker metadata for their feature teams.

By using a crowd sourcing approach, there is strong social pressure for the responsible persons to keep AP and owner tracker metadata current. For example, if Jane Doe was previously responsible for a particular AP, but no longer is, and she is assigned a bug report for an identified target component related to that AP—perhaps because someone failed to update the AP metadata —then there is strong motivation/social pressure for Jane to make sure the AP metadata gets properly updated for at least two reasons: (1) so that the bug report will get reassigned to a more appropriate relevant owner, and (2) so that she will not keep being assigned bug reports for that identified target component. Thus, the crowd sourcing aspect of owner controller 214, and the resulting social pressure created by stale metadata, promotes timely updating of the AP and owner tracker metadata by the persons closest to the metadata. This has the further benefit of reducing the need for top-down management of the AP and owner tracker metadata, a function that can be costly, slow, and error-prone.

FIG. 3 is a block diagram showing an example owner tracker 212, a component of system 200 that is configured for identifying relevant owners responsible for target components. Owner tracker 212 typically includes several components including owner mining component 310, owner tracker database 320, calculated benchmark ranking (“CBR”) calculator 330, manager calculated benchmark ranking (“MCBR”) calculator 340, and owner tracker controller 350. Each of these components (including any sub-components) may be implemented as a system comprising a hardware logic device(s) (e.g., an integrated circuit or a device comprising such circuits), a computing device (such as described in connection with FIG. 1 or the like) that executes instructions to perform the requisite method(s), a service comprising a set of devices (including one or more such as described in connection with FIG. 1 or the like), or as some combination of the foregoing Each such component may be implemented on/by one device, such as a hardware logic device or computing device, or across multiple such devices. For example, a component may be implemented in a distributed fashion on/by multiple devices such as, for example, servers or elements of a network service or web site or the like. Further, each such component (including any sub-components) may encompass one or more sub-components or the like, and the components may be implemented as separate components, or any two or more may be combined in whole or in part. The division of components described herein is non-limiting except where indicated, and is intended primarily to aid in describing aspects of the invention.

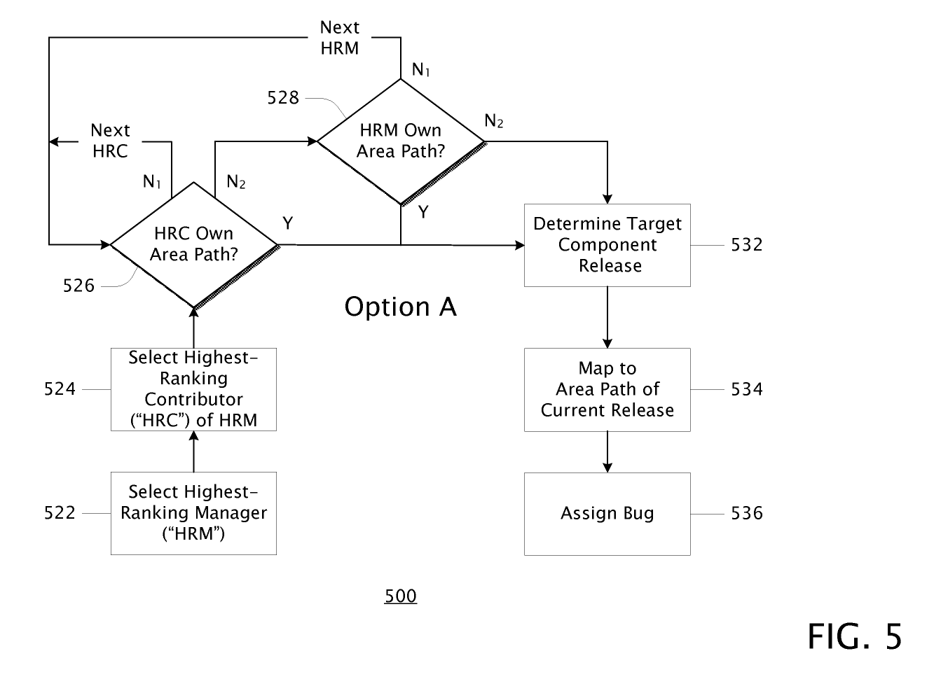

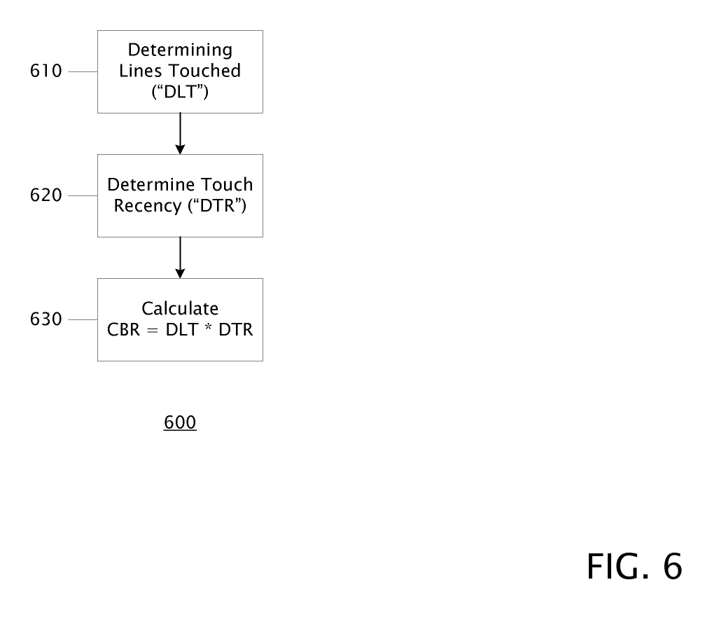

In one example, owner tracker 212 is a component of system 200 that is configured for identifying relevant owners responsible for target components. In one example, this identifying is used for mapping a particular bug report for an identified target component to a relevant owner who is responsible for handling the bug report. Such identifying by owner tracker 212 is based on information from and interaction with other components of system 200. This mapping involves a request for owner tracker 212 to provide a relevant owner for a target component such as from client request controller 216. Such a bug report may be a new, incoming bug report or may be pre-existing in a bug database such as bug database 270. The identifying involves performing a method such as that described in connection with FIG. 5 or the like.

Ownership mining component 310 is a component of owner tracker 212 that is typically configured for mining (e.g., searching for) ownership information from various databases that can be used to identify relevant owners of target components such as are identified in bug reports. Such databases include, but are not limited to, code databases such as code database 260, bug databases such as bug database 270, and employee databases such as employee database 280. Other databases or systems that may alternatively or additionally be searched include build systems such as build system 218 of FIG. 2, databases of network users such as an active directory (“AD”) or other network directory or the like, and any other database or source of information that can be used to identify relevant owners of target components such as those identified in bug reports.

In one example, owner mining subcomponent 312 may be dedicated to searching code databases such as code database 260. In another example, bug mining subcomponent 314 may be dedicated to searching bug databases such as bug database 270. And in another example, owner consolidation subcomponent 326 may be dedicated to searching developer databases such as employee database 280 and/or other databases, sources, and/or systems that may provide historical and/or current information identifying persons that may be relevant owners as well as managers and direct reports of the persons.

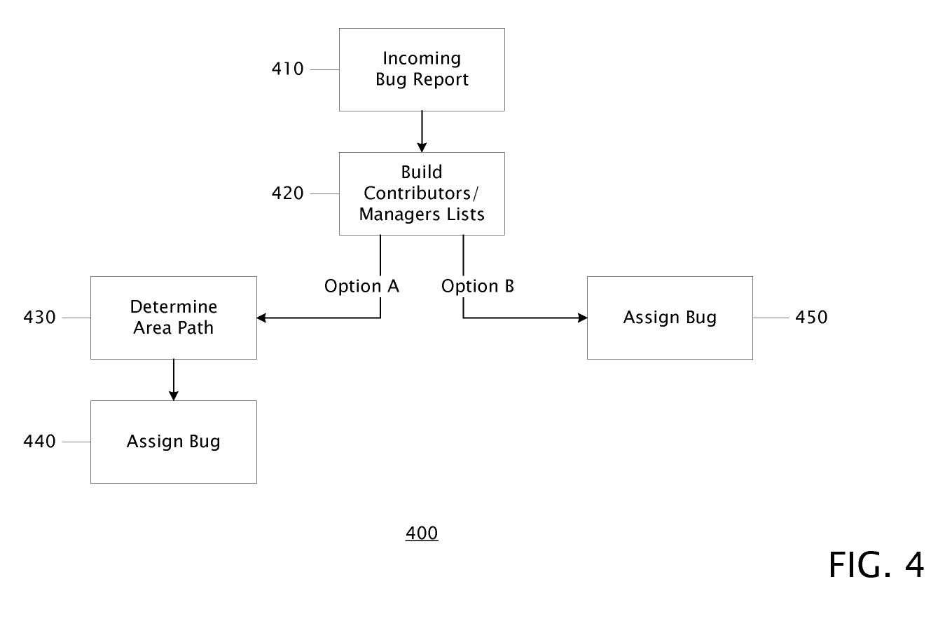

The mined information typically includes identification of particular persons and of particular target components and/or corresponding target component sources (e.g., source files that are used to generate target components that are binary files or executable files or the like), and relationships between the three. In some examples, such as with software products, a source file that corresponds to a target component may be identified as the target component for purposes of determining an AP and identifying a relevant owner for the target component, such as accomplished by methods 400 and 500 of FIGS. 4 and 5. Such mined information and/or references to such information may be stored in owner tracker database 320 at least in the form of suggestions 322 and consolidated owner information 326. In one example, suggestions 322 identify suggested relevant owners and suggested relationships between such and with various potential target components. Suggestions 322 may also include blacklists or the like such as described in connection with method 500 of FIG. 5. In one example, consolidated owner information 326 represents a consolidation of all information, and/or references to such information, available via ownership mining component 310. Such consolidated information and/or references to such may be accessed from its various sources, such as databases 260, 270, and 280, in real-time and/or may be collected over time and made available from owner tracker database 320.

Owner tracker database 320 may also include assertions 324. In one example, such assertions are submitted via owner controller 214 or the like and typically identify overrides provided by users of system 200. In particular, an “assertion” is a user-provided mapping between a particular person and a particular target component, or a particular person and a particular AP. For example, an assertion may be entered that identifies Mary Jones as the triage lead of the Project X Client Team AP regardless of any other information in the AP hierarchy and/or other sources. Given such an assertion, Mary Jones would override any other possible persons as the triage owner for the Project X Client Team AP. In another example, an assertion may be entered that identifies John Smith as the relevant owner of target component foo.exe regardless of any other information in the AP hierarchy and/or other sources. Given such an assertion, John Smith would override any other possible persons as the relevant owner of target component foo.exe. Any number of such assertions may be entered, modified, and/or removed, typically via owner controller 214 or the like.

Calculated benchmark ranking (“CBR”) calculator 330 is a component of owner tracker 212 that is configured to calculate a CBR for a contributor to a target component. In one example, CBR calculator 330 accepts as input an identification of the particular contributor to the particular target component, identification of a list of contributors relevant to the CBR calculation (such as identified in block 510 of FIG. 5), and identification of the target component and/or of a source file that corresponds to the target component. Given these identifications, CBR calculator 330 typically calculates a CBR for the particular contributor to the particular target component by performing a method such as that described in connection with FIG. 6 or the like.

In one example, CBR calculator 330 stores (or provides for storage) CBRs in association with and/or so as to identify their corresponding contributors in owner tracker database 320. In one example, CBR calculator 330 calculates CBRs on-demand, such as when requested by owner tracker controller 350, and makes requested CBRs available (e.g., returns requested CBRs) to the requestor either directly and/or via owner tracker database 320. In another example, CBR calculator 330 calculates and stores (or provides for storage) CBRs opportunistically (e.g., when not busy with other requests such as on-demand requests), under the direction of owner tracker controller 350 or otherwise. In this manner CBRs may be readily available in owner tracker database 320 when needed, thus minimizing any waiting for potentially slower on-demand calculations.

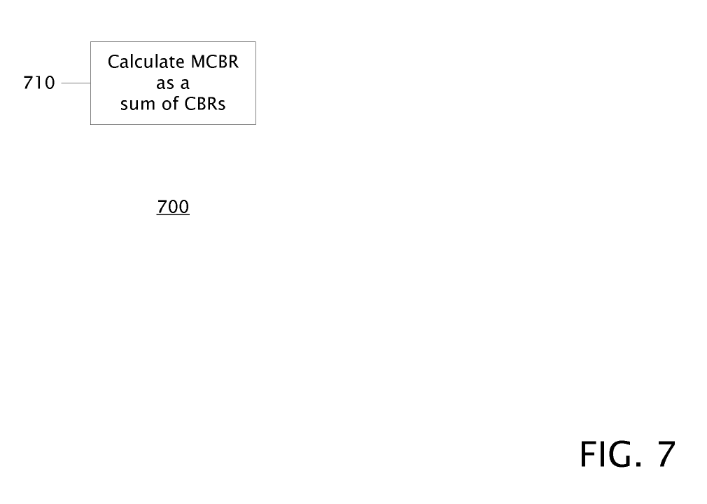

Manager calculated benchmark ranking (“MCBR”) calculator 340 is a component of owner tracker 212 that is configured to calculate a MCBR for a particular manager relative to a particular target component. In one example, MCBR calculator 340 accepts as input an identification of the particular manager and an identification of the CBRs for the manager's direct report contributors to the particular target component. Given these identifications, MCBR calculator 340 typically calculates a MCBR for the particular manager relative to the particular target component by performing a method such as that described in connection with FIG. 7 or the like.

In one example, MCBR calculator 340 stores (or provides for storage) MCBRs in association with and/or so as to identify their corresponding managers in owner tracker database 320. In one example, MCBR calculator 324 calculates MCBRs on-demand such as when requested by owner tracker controller 350 and makes requested MCBRs available (e.g., returns requested MCBRs) to the requestor either directly and/or via owner tracker database 320. In another example, MCBR calculator 340 calculates and stores (or provides for storage) MCBRs opportunistically (e.g., when not busy with other requests such as on-demand requests), under the direction of owner tracker controller 350 or otherwise. In this manner MCBRs may be readily available in owner tracker database 320 when needed, thus minimizing any waiting for potentially slower on-demand calculations.

Owner tracker controller 350 is a component of owner tracker 212 that is typically configured for controlling the operations of owner tracker 212. Owner tracker controller 350 may be implemented as a system comprising a hardware logic device(s) (e.g., an integrated circuit or a device comprising such circuits), a computing device (such as described in connection with FIG. 1 or the like) that executes instructions to perform a method such as that described in connection with FIG. 5 or the like, a service comprising a set of devices (including one or more such as described in connection with FIG. 1 or the like), or as some combination of the foregoing. One or more of the other components of owner tracker 212 may also be implemented as part of the same system.

In general, owner tracker controller 350 is a system that performs a method such as that described in connection with FIG. 5 or the like and, in so doing, interacts with other components of owner tracker 212 and system 200 so as to control and configure owner tracker 212 to identify relevant owners responsible for target components.

FIG. 4 is a block diagram showing an example method 400 for mapping any particular bug report for a particular target component to a relevant owner who is responsible for handling the bug report. In one example, method 400 is performed by system 200. In general, method 400 accepts an incoming bug report (or information from the bug report) as input, builds lists of contributors to a source file that is the subject of the bug report, along with managers of those contributors, and assigns the bug report. Further, in one opt on (Option A), method 400 determines an area path (“AP”) that corresponds to the source file, and then assigns the bug report based on the determined area path. In another option (Option B), the hug report is assigned directly based on the contributor/manages lists. Method 400 typically begins at block 410.

Block 410 of method 400 typically indicates receiving an incoming bug report such as via client request controller 216 of system 200 or the like. Upon receipt, such a bug report typically includes data that indicates a particular target component that experienced a problem of some sort. In particular, such a received bug report typically includes, or is processed by client request controller 216 or the like to include, an identification of the target component. A bug report may be received directly or indirectly from any client of system 200 or the like. That is, a bug report itself may be received or an identification of the bug report may be received sufficient to locate the bug report itself. In such latter cases, the bug report may actually be located in bug database 270 or the like. Alternatively, or additionally, an identification of the particular target component that is the subject of the bug report may be received. Once a bug report (or its identification or an identification of the particular target component) s received, method 400 typically continues at block 420.

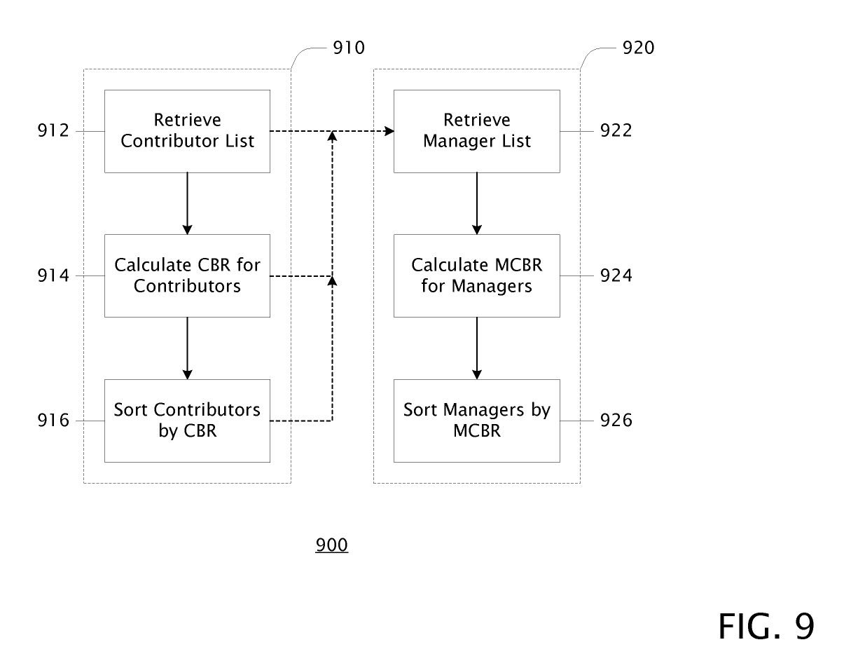

Block 420 of method 400 typically indicates building a list of contributors to the source file that is the subject of the bug report, as well as building a list of the managers of the contributors. These lists are then sorted according to particular rankings. In one example, the process for building these lists, computing the rankings, and so sorting the lists according to the rankings is described in FIG. 9 and the corresponding written description. Given the ranked and sorted lists, method 400 typically continues at either block 430 for Option A or at block 450 for Option B.

Block 430 of method 400 typically indicates determining, such as via owner tracker 212 of system 200, an AP that corresponds to the target component that is the subject of the bug report. In one example, the process for determining an AP that corresponds to the target component of the bug report is described in FIG. 5 and the corresponding written description. Further, an output of block 430 may include an identification of a relevant owner for the target component of the bug report. Once an AP is determined, method 400 typically continues at block 440.

Block 440 of method 400 typically indicates assigning the received/identified bug report to the relevant owner identified from the determined AP that corresponds to the target component of the bug report, as determined at block 420 or the like. In one example, the relevant owner is indicated in the bug report by setting an owner field or the like in the bug report to indicate the relevant owner. In another example, the relevant owner is indicated in the bug report by setting a field to indicate the team or the like responsible for the bug report. If the assigned bug report is not already in bug database 270 then it may be added to bug database 270 via conventional means. At this point in method 400 the received/identified bug report is now assigned to a relevant owner and method 400 is complete.

FIG. 5 is a block diagram showing an example method 500 for determining, in a particular AP hierarchy structure, a particular area path (“AP”) that corresponds to an identified target component. In one example, method 500 is performed by owner tracker 212 of system 200 as “Option A”. In one example, method 500 accepts received bug reports (or their identification) as input and determines area paths (“APs”) that correspond to the target components identified by the bug reports. Identified bug reports may be stored and maintained in bug database 270 or in a store of client request controller 216 or the like. In another example, method 500 determines a particular AP based on a request, such as from client request controller 216, to identify a relevant owner of an identified target component. In this example, such a request may identify or include a bug report directed to the identified target component. Various steps of method 500 also typically access a contributors list and a managers list such as those described in FIG. 9 and the corresponding written description. Further, in some examples, various steps of method 500 may be performed in a different order than the order shown. Method 500 typically begins at block 522.

Block 522 of method 500 typically indicates selecting, such as by owner tracker 212 of system 200, the highest-ranking manager (“HRM”) from a managers list for the identified target component, such as the managers list of block 920 of FIG. 9. Once the HRM has been selected, method 500 typically continues at block 524.

Block 524 of method 500 typically indicates selecting, such as by owner tracker 212 of system 200, the highest-ranking contributor (“HRC”) from a list of contributors to the identified target component, such as the contributors list of block 910 of FIG. 9, where the HRD is managed by the HRM. Alternatively, the HRC may be selected independent of the HRM. That is, selecting the highest-ranking contributor from the contributors list without regard to whether or not the HRC is managed by the HRM. Once the HRC has been selected, method 500 typically continues at block 526.

Block 526 of method 500 typically indicates determining, such as by owner tracker 212 of system 200, if the selected HRC owns an AP in the particular AP hierarchical structure. If the HRC does own an AP in the particular AP hierarchical structure, then that AP is selected, the HRC is considered the relevant owner of the identified target component, and method 500 typically continues at block 532. Otherwise, the next-highest-ranking contributor from the list of contributors to the identified target component (who is managed by the HRM) is considered the new HRC and method 500 typically repeats at block 526 via path N₁. If there are no more next-highest-ranking contributors on the list of contributors to the identified target component (who are managed by the HRM) to select from, then method 500 typically continues at block 528 via path N₂.

Block 528 of method 500 typically indicates determining, such as by owner tracker 212 of system 200, if the HRM owns an AP in the particular AP hierarchical structure. If the HRM does own an AP in the particular AP hierarchical structure, then that AP is selected, the HRM is considered the relevant owner of the identified target component, and method 500 typically continues at block 532. Otherwise, the next-highest-ranking manager is considered the new HRM and method 500 typically repeats at block 526 via path N₁. If there are no more next-highest-ranking managers in the list of managers to select from, then a particular person—e.g., a “director”—that is designated to receive such special case bug reports is considered the relevant owner via path N₂—i.e., bug reports for which a relevant owner cannot be found by searching area paths. Further, the AP owned by the director (the relevant owner in this case) is designated as the selected AP. If a director is considered the relevant owner, then method 500 typically continues at block 532.

Block 532 of method 500 typically indicates determining, such as by owner tracker 212 of system 200, to what release—known as the “relevant release”—the identified target component belongs based on the selected AP. That is, the identified target component that corresponds to the selected AP owned by the relevant owner will typically be part of a particular release of a particular product. In this context, the term “release” refers to a version of the product, a serial number or serial number range of the product, a particular run of the product, a particular ship date/time or date range of the product, or any other identification of the particular “release” of the product for use in final or pre-final form (e.g., a final release, beta release, evaluation release, or the like). In one example, the release of a software product is indicated by a version number of the software product.

In one example, a relevant release is determined based on metadata of the selected AP, such as from the example “Release” field of the AP's metadata, Once a relevant release of the product that includes the identified target component is determined, then method 500 typically continues at block 534.

Block 534 of method 500 typically indicates mapping, such as by owner tracker 212 of system 200, the relevant release determined at block 532 to a “current release”—the latest release of the product that includes the identified target component. In one example, this mapping is performed by tracing, such as by AP controller 210, the identified target component's AP owned by the relevant owner that corresponds to the relevant release within the AP hierarchical structure to the identified target component's AP of the current release (known as the “current AP”).

Further, the relevant owner may be updated to one of the persons listed in the metadata of the current AP. In one example, the relevant owner is updated to be the person identified by the example DevOwner field of the current AP's metadata. In another example, the relevant owner is updated to be the person identified by the example TriageOwner field of the current AP's metadata. In another example, the relevant owner is updated to an owner of the current AP. In another example, the relevant owner is updated to “Active” or some similar label indicating that a specific person will be identified based on the current AP. Which person is selected as the relevant owner may depend of what stage of development the corresponding product is in. For example, if the product is in a pre-release stage (e.g., a beta release), then a triage lead may be selected as the updated relevant owner. Otherwise, a development lead may be selected as the updated relevant owner. In other examples, some other person listed in the current AP's metadata may be selected as the updated relevant owner. Once the current AP of the identified target component is determined and the relevant owner is updated, method 500 typically continues at block 536.

Block 536 of method 500 typically indicates assigning the bug report identifying the target component to the relevant owner. In one example, this is done by setting the example “AssignedTo” field or the like of the bug report to the relevant owner, and may further include setting the example “Team” field or the like of the bug report to the current AP. Once the bug report is assigned to the relevant owner and to the current AP, method 500 is typically complete.

Some exceptions to the operation of method 500 follow. First, each code database, such as code database 260, may have its own director—the particular person designated to receive special case bug reports when a relevant owner cannot be found by searching area paths. Alternatively, directors may be designated at other levels, such as across multiple code databases (a higher level) or for various projects or sub-projects (lower levels).

Second, in one example, if a contributor or manager owns more than one area path (e.g., see blocks 526 and 528 of FIG. 5) then the highest level AP in the AP hierarchy owned by the contributor or manager is typically selected (i.e., toward the root node vs the leaf nodes).

Third, in one example, owner tracker 212 comprises a blacklist of persons not to be considered as the relevant owner when determining area path ownership (e.g., see blocks 526 and 528 of FIG. 5). Such a blacklist typically includes persons that fit at least one of the following descriptions: (a) persons that have contributed to source files in more than a particular threshold of APs, AP hierarchical data structures, and/or databases such as code database 260 that are involved in system 200, where one example threshold is ten (10) code databases; and (b) certain persons who can contribute to target components but still do not own the target components, such as builders typically associated with build system 218 or the like.

FIG. 6 is a block diagram showing an example method 600 for calculating a calculated benchmark ranking (“CBR”) for a particular contributor to a identified target component. In one example, method 600 is performed by CBR calculator 330 of owner tracker 212. In one example, method 600 accepts as input an identification of the particular contributor to the identified target component, an identification of a list of contributors relevant to the CBR calculation (such as identified in block 510 of FIG. 5), and an identification of the identified target component and/or of a source file that corresponds to the identified target component. Such a source file is typically stored in code database 260 or the like. Further, in some examples, at least steps 610 and 620 may be performed in a different order than the order shown. Method 600 typically begins at block 610.

Block 610 typically indicates determining, such as by CBR calculator 330 of owner tracker 212, a number of lines of code in the source file that were touched (i.e., modified, removed, and/or added) in the source file by the particular contributor. In one example, the number of lines of code touched (i.e., the determined lines touched “DLT”) is retrieved from code database 260. In one example, the determined number of lines of code touched is the total number of lines touched by the particular contributor. In another example, the determined number of lines of code touched is the total according to various touch commands (i.e., adding, removing, or changing lines of code) performed in the source file by the particular contributor. In other examples, alternative or additional methods may be used to determine the number of lines of code that were touched in the source file by the particular contributor. Once the number of lines touched in a source file by the particular contributor has been determined, method 600 typically continues at block 620.

Block 620 typically indicates determining, such as by CBR calculator 330 of owner tracker 212, a “recency” value that represents a measure of how recently lines of the source file were touched by the particular contributor. In one example, the recency value (i.e., the determined touch recency “DTR”) is based on the most recent touch to the code of the source file by the particular contributor relative to the oldest most recent touch by all of the contributors on the list of contributors (such as retrieved at block 510 of FIG. 5) to the code of the source file. For example, a recency value can be determined based on the following computation: (1) let todaysDate equal today's date, i.e., the date of the computation; (2) let changeDate equal the oldest of the most recent touch dates of the contributors on the list of contributors, (3) let totalDays equal the difference in the number of days between changeDate and; (4) let contributorDays equal the difference in the number of days between the date of the most recent touch to the code of the source file by the particular contributor and todaysDate; and (5) let recencyValue equal contributorDays divided by totalDays, where the recencyValue represents a measure of how recently lines of the source file were touched by the particular contributor relative to the oldest most recent touch by all of the contributors on the list of contributors. In other examples, alternative or additional computations or methods may be used to determine the recency value. Once the recency value has been determined, method 600 typically continues at block 630.

Block 620 typically indicates calculating, such as by CBR calculator 330 of owner tracker 212, a calculated benchmark ranking (“CBR”) for the particular contributor to the identified target component. In general, a CBR is a weighted contribution ranking of a contributor to a target component. In an example where a source file corresponds to the target component, the weighted contribution ranking is based on a DLT—a determined number of lines of code in the source file that were touched in the source file by the particular contributor (such as determined at block 610) multiplied by a weighting factor, the DTR—a determined recency value that represents a measure of how recently lines of the source file were touched by the particular contributor relative to the oldest most recent touch by all of the contributors to the source file (such as determined at block 620) on theist of contributors (such as retrieved at block 510 of FIG. 5). For example, a CBR for the particular contributor to the identified target component that corresponds to the source file can be determined based on the following computation: (1) let CBR equal DLT multiplied by DTR. In other examples, alternative or additional computations or methods may be used to calculate a CBR for a contributor to a target component. Once a CBR has been determined, method 600 is typically complete.

FIG. 7 is a block diagram showing an example method 700 for calculating a manager calculated benchmark ranking (“MCBR”) for a particular manager relative to a identified target component, the particular manager such as from a manager list (such as retrieved at block 512 of FIG. 5). In one example, method 700 is performed by MCBR calculator 340 of owner tracker 212. In one example, method 700 accepts as input an identification of the particular manager and an identification of the CBRs of the manager's direct report contributors to the identified target component. Such identifications are typically stored in owner tracker database 320 or the like. Method 700 typically begins at block 710.

Block 710 typically indicates calculating, such as by MCBR calculator 340 of owner tracker 212, a manager calculated benchmark ranking (“MCBR”) for the particular manager in the manager list (such as retrieved at block 512 of FIG. 5). In general, a MCBR is a weighted contribution ranking for a manager that is based on the manager's direct report contributors to a target component. In one example, the particular manager's weighted contribution ranking is based on a sum of the CBRs of the particular manager's direct report contributors to the identified target component (such as calculated at block 514 of FIG. 5). For example, a MCBR for the particular manager relative to the identified target component is determined based on the following computation: (1) let MCBR equal the sum of the CBRs of the particular manager's direct report contributors to the identified target component. In other examples, alternative or additional computations or methods may be used to calculate a MCBR for a manager relative to a target component. Once a MCBR has been determined, method 700 is typically complete.

FIG. 8 is a block diagram showing an example simplified hierarchical structure of an example source tree maintained in an example code database such as code database 260. This example shows a simplified example of a hierarchical tree structure for fictitious ProductX which is represented by its top-level directory 810. This top-level directory may comprise any number of source files and subdirectories, including example subdirectories 820, 822, and 824 designated as example features 1, 2, and 3 of ProductX. The source tree generally comprises source code metadata for each source file stored in any source tree directory. Such metadata may be maintained as part of the code database or some other database(s), as part of the source tree, as part of the directory comprising the source file, and/or associated with the source file itself. Any directory of a source tree (e.g., 820) may have a parent directory (e.g., 810), zero or more sibling directories (e.g., 822 and 824), and zero or more child directories (e.g., e.g., 830, 832, 840, and 850). Such directories may be created as desired to organize the source files maintained in the source tree.

FIG. 9 is a block diagram showing an example method 900 for building a list of contributors to a source file that is the subject of a bug report, as well as building a list of the managers of the contributors. In one example, method 900 is performed by owner tracker 212 of system 200. In general, method 900 accepts as input an identification of a target component, such as a target component that is the subject of a bug report. In one example, the identified target component is a source file. The output of method 900 is typically a first list of contributors to the identified target component (the “contributors list”) where the contributors 1st is sorted according to a first particular ranking of each of the contributors, as well as a second list of managers of the contributors to the identified target component (the “managers list”) where the managers list is sorted according to a second particular ranking of each of the managers. Block 910 comprises example steps of method 900 for building the sorted contributors list, and block 920 comprises example steps of method 900 for building the managers list. Further, in some examples, the steps may be performed in a different order than the order shown. Method 900 typically begins at block 912.

Block 912 of method 900 typically indicates retrieving, such as by owner tracker 121 of system 200, a list of contributors to the identified target component. In this example, the term “contributor” refers to persons who have contributed to the target component from an engineering, development, and/or maintenance perspective. As a simplified example, the identified target component may be HelloWorld.exe, a hypothetical software product that threw an exception (or for which any problem was indicated or identified) on a machine on which it was executing, thus resulting in a bug report or the like identifying HelloWorld.exe as the identified target component. Persons who are contributors to HelloWorld.exe (as with any other target component) include those persons who originally wrote the HelloWorld source code, made additions, modifications, and/or deletions to the code (such as overtime), made bug fixes to the code, and other engineering, development, and/or maintenance contributions or the like to the code. In one example, a “contribution” to a target component, at least where such a component is a software component, refers to lines of code originally created, added, modified, deleted, fixed, and the like. Contributors that make such contributions to target components stored in code database 260 or the like are typically identified by source code metadata.

In one example, owner tracker 212 of system 200 retrieves a list of contributors to the target component from a source(s) such as code database 260 or the like. Such retrieved lists of contributors may be stored and maintained in owner tracker database 320. In another example, a contributor list is simply identified as opposed to actually being retrieved, where such a list is maintained in a code database(s) or the like that is accessed by owner tracker 212 of system 200. The terms “retrieving” in all its forms as used herein with respect to an object refer to the object itself (e.g., the object being a contributor list) and/or to an identifier of the object (e.g., an identifier of the contributor list sufficient to locate and access the list) regardless of the context in which the term is used, except where explicitly stated otherwise.

In some cases, the number of contributors to the target component may be relatively small, under a threshold for a minimum number of contributors. In such cases, neighboring contributors may be considered contributors and may also be added to the contributors list. A “neighboring contributor” is a contributor to a neighboring component of the identified target component. A “neighboring component” is a component in the same directory of the source tree as the identified target component. In addition, a neighboring component may also be any component in a child directory, sibling directory, and/or parent directory to the directory of the identified target component. In one example where the number of contributors to the identified target component is below the threshold for a minimum number of contributors, neighboring contributors may be added to the contributors list by adding the contributors to the neighboring components from the directory of the identified target component and/or any child, sibling, and parent directories to the directory of the identified target component based on any desired order or algorithm. In this example, once the minimum number of contributors have been added to the contributor list, the contributor list retrieval is considered complete.

A retrieved contributor list typically comprises the names of the contributors and/or theft identifiers or the like sufficient to map back to descriptions of the contributors as listed in an employee database(s) or the like, such as employee database 280. Note that one or more of the contributors may no longer be a member of the team or group, or with the company or organization responsible for the target component. Once the list of contributors has been retrieved, method 900 typically continues at block 914. Further, once the contributor list has been retrieved, or after any of steps 914 and 916 are complete, method 900 may additionally continue at block 922.

Block 914 of method 900 typically indicates calculating, such as by CBR calculator 330 of owner tracker 212, a calculated benchmark ranking (“CBR”) for each contributor in the contributor list retrieved at block 912. In one example, the process for calculating the CBRs is described in FIG. 6 and the corresponding written description. Each CBR is relative to the identified target component and typically indicates a weighted amount or degree of contribution by its corresponding contributor. In one example, a larger CBR value indicates a greater contribution to the identified target component by the contributor. Each CBR is typically stored in association with and/or so as to identify its corresponding contributor. Such CBRs may be stored and maintained in owner tracker database 320. Such CBRs may be calculated off-line; that is, at any opportune time independent of any received/indicated bug reports, request for contributor/manager lists, or the like. Alternatively or additionally, such CBRs may be calculated in response to a received/indicated bug report(s), a request(s) for contributor/manager lists, or the like. Once the CBRs for the list of contributors have been calculated, method 900 typically continues at block 916.

Block 916 of method 900 typically indicates sorting, such as by owner tracker 212 of system 200, the list of contributors based on their CBRs. In one example, contributors that have made greater contributions to the identified target component are listed above contributors that have made lesser contributions. Such sorted lists of contributors, or indications of the sorted order, may be stored and maintained in owner tracker database 320. Once the list of contributors has been sorted by their CBRs, method 900 typically continues at block 922 if not previously.

Block 922 of method 900 typically indicates retrieving, such as by owner tracker 121 of system 200, a list of managers of the contributors listed at block 912. The term “manager” in this context typically refers to an immediate manager of a particular direct-report contributor. Such a manager may be a team lead of a feature team or the like. Such a manager may additionally or alternatively be the manager of a group that includes various contributors and that may include one or more feature teams or the like. Identification of such managers of contributors may be stored and/or maintained in a code database(s) such as code database 260, in an employee database(s) such as employee database 280, and/or in some other database(s) or the like; where any combination of the foregoing is referred to herein as a “manager source”. Thus, in one example, owner tracker 212 of system 200 retrieves a list of managers of the contributors to the identified target component from a manager source(s). Such retrieved lists of managers may be stored and maintained in owner tracker database 320. In another example, a manager list is simply identified as opposed to actually being retrieved, where the list is maintained in a manager source(s) that is accessed by owner tracker 212 of system 200.

In some cases, the number of managers of the contributor to the target component may be relatively small, under a threshold for a minimum number of managers. In such cases, neighboring managers may be considered managers and may also be added to the managers list. A “neighboring managers” is a manager of a contributor to a neighboring component of the identified target component, as described in relation to block 912. In one example where the number of managers of contributors to the identified target component is below the threshold for a minimum number of managers, neighboring managers may be added to the managers list by adding the managers of the contributors to the neighboring components from the directory of the identified target component and/or any child, sibling, and parent directories to the directory of the identified target component based on any desired order or algorithm. In this example, once the minimum number of managers has been added to the managers list, the managers list retrieval is considered complete.

A retrieved manager list typically comprises identification of the managers sufficient to map back to descriptions of the managers as listed in an employee database(s) or the like, such as employee database 280. Note that one or more of the managers may no longer be a member of the team or group, or with the company or organization responsible for the identified target component. Once the list of managers has been retrieved, method 900 typically continues at block 924.

Block 924 of method 900 typically indicates calculating, such as by MCBR calculator 340 of owner tracker 212, a manager calculated benchmark ranking (“MCBR”) for each manager in the manager list retrieved at block 512. In one example, the process for calculating the MCBRs is described in FIG. 7 and the corresponding written description. Each MCBR is relative to the identified target component and typically indicates a weighted amount or degree of contribution by its corresponding manager's direct-report contributors. In one example, a larger MCBR value indicates a greater contributor to the identified target component by contributors managed by the corresponding manager. Each MCBR is typically stored in association with and/or so as to identify its corresponding manager. Such MCBRs may be stored and maintained in owner tracker database 320. Such MCBRs may be calculated off-line; that is, at any opportune time independent of any received/indicated bug reports, request for contributor/manager lists, or the like. Alternatively or additionally, such MCBRs may be calculated in response to a received/indicated bug report(s), a request(s) for contributor/manager lists, or the like. Once the MCBRs for the list of managers have been calculated, method 900 typically continues at block 926.

Block 926 of method 900 typically indicates sorting, such as by owner tracker 212 of system 200, the list of managers based on their MCBRs. In one example, managers of contributors that have made greater contributions to the identified target component are listed above managers of contributors that have made lesser contributions. Such sorted lists of managers, or indications of the sorted order, may be stored and maintained in owner tracker database 320. Once the list of managers has been sorted by their MCBRs, and the other steps of method 900 are complete, method 900 is typically complete.

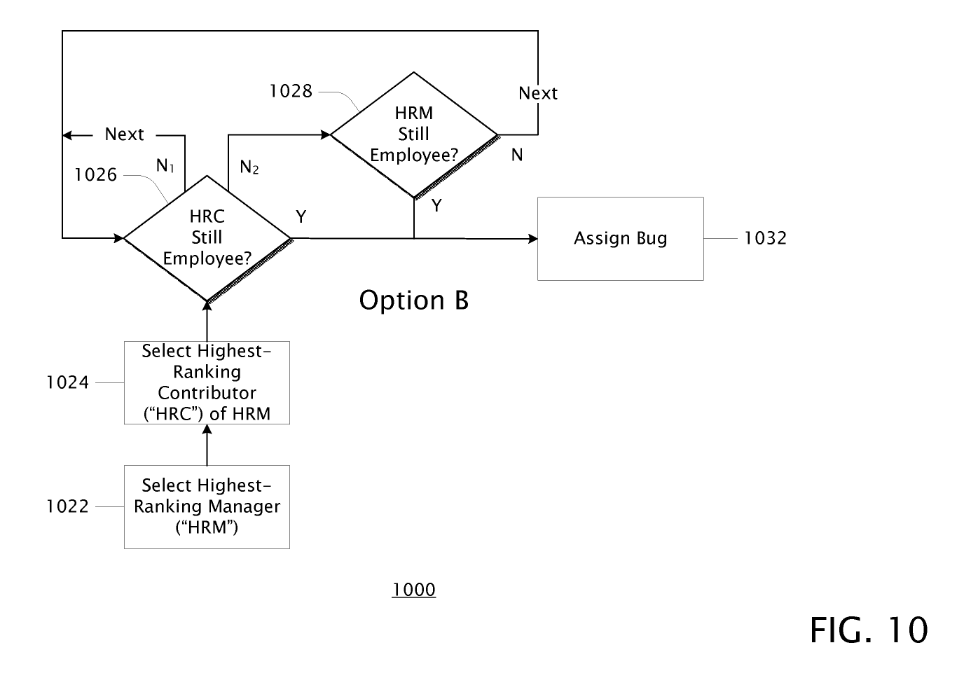

FIG. 10 is a block diagram showing an example method 1000 for determining a relevant owner and team that corresponds to an identified target component. In one example, method 1000 is performed by owner tracker 212 of system 200 as “Option B” which does not make use of Area Paths. In one example, method 1000 accepts received bug reports (or their identification) as input and determines relevant owners and teams that correspond to the target components identified by the bug reports. In another example, method 1000 determines a relevant owner and/or team based on a request, such as from client request controller 216, to identify a relevant owner of an identified target component. In this example, such a request may identify or include a bug report directed to the identified target component. Various steps of method 1000 also typically access a contributors list and a managers list such as those described in FIG. 9 and the corresponding written description. Further, in some examples, various steps of method 1000 may be performed in a different order than the order shown. Method 1000 typically begins at block 1022.

Block 1022 of method 1000 typically indicates selecting, such as by owner tracker 212 of system 200, the highest-ranking manager (“HRM”) from a managers list for the identified target component, such as the managers list of block 920 of FIG. 9. Once the HRM has been selected, method 500 typically continues at block 1024.

Block 1024 of method 500 typically indicates selecting, such as by owner tracker 212 of system 200, the highest-ranking contributor (“HRC”) from a list of contributors to the identified target component, such as the contributors list of block 910 of FIG. 9, where the HRD is managed by the HRM. Alternatively, the HRC may be selected independent of the HRM. That is, selecting the highest-ranking contributor from the contributors list without regard to whether or not the HRC is managed by the HRM. Once the HRC has been selected, method 1000 typically continues at block 1026.

Block 1026 of method 1000 typically indicates determining, such as by owner tracker 212 of system 200, if the selected HRC is currently an employee of the company responsible for the identified target component. In one example, determining if the selected HRC is currently an employee includes checking an employee database(s), to see if the HRC is currently an employee of the company responsible for the identified target component. If the HRC is currently an employee, then the team of which the employee is a member (as indicated by employee database 280 or the like) is selected, the HRC is considered the relevant owner of the identified target component, and method 1000 typically continues at block 1032. Otherwise, the next-highest-ranking contributor from the list of contributors to the identified target component (who is managed by the HRM) is considered the new HRC and method 1000 typically repeats at block 1026 via path N₁. If there are no more next-highest-ranking contributors on the list of contributors to the identified target component (who are managed by the HRM) to select from, then method 1000 typically continues at block 1028 via path N₂.

Block 1028 of method 1000 typically indicates determining, such as by owner tracker 212 of system 200, if the HRM is currently an employee of the company responsible for the identified target component. In one example, determining if the selected HRM is currently an employee includes checking an employee database(s), to see if the HRM is currently an employee of the company responsible for the identified target component. If the HRM is currently an employee, then the team of which the employee is a member (as indicated by employee database 280 or the like) is selected, the HRM is considered the relevant owner of the identified target component, and method 1000 typically continues at block 1032. Otherwise, the next-highest-ranking manager is considered the new HRM and method 1000 typically repeats at block 1026 via path N₁. If there are no more next-highest-ranking managers in the list of managers to select from, then a particular person—e.g., a “director”—that is designated to receive such special case bug reports is considered the relevant owner via path N₂—i.e., bug reports for which a relevant owner cannot be found by searching area paths. Further, the team or division or the like of the director (the relevant owner in this case) is designated as the selected team. If a director is considered the relevant owner, then method 1000 typically continues at block 1032. In another example, the relevant owner is set to “Active” or some similar label indicating that a specific person will be identified based on the selected team, and then method 1000 typically continues at block 1032.

Block 1032 of method 1000 typically indicates assigning the bug report identifying the target component to the relevant owner. In one example, this is done by setting the example “AssignedTo” field or the like of the bug report to the relevant owner, and may further include setting the example “Team” field or the like of the bug report to the selected team. Once the bug report is assigned to the relevant owner and to the selected team, method 500 is typically complete.

### CONCLUSION

In a first example, a method is performed on at least one computing device, the method comprising: receiving, by the at least one computing device, a request to identify a relevant owner of an identified target component; calculating, for each contributor of a plurality of contributors to the identified target component by a calculated benchmark ranking (“CBR”) calculator of the at least one computing device, a CBR; selecting, by an owner tracker controller of the at least one computing device based at least in part on the CBRs, an area path (“AP”) that is owned by a contributor of the each contributors, where the selected AP is in an AP hierarchy that corresponds to the identified target component; mapping, by the owner tracker controller, the selected AP to a current AP; and identifying, by the owner tracker controller based on the current AP, the relevant owner for the identified target component.

In a second example, at least one computing device comprises: at least one processor; memory coupled to the at least one processor; an owner tracker via which the at least one computing device receives a request to identify a relevant owner for a target component; a calculated benchmark ranking (“CBR”) calculator via which the owner tracker calculates, for each contributor on a list of contributors to the identified target component, a CBR; an owner tracker controller via which the owner tracker selects, based at least in part or the CBRs, an area path (“AP”) that is owned by a contributor of the each contributors, where the selected AP is in an AP hierarchy that corresponds to the identified target component; the owner tracker controller via which the owner tracker maps the selected AP to a current AP; and the owner tracker controller via which the owner tracker identifies, based on the current AP, the relevant owner for the identified target component.

In a third example, there is at least one computer-readable medium that comprises computer-executable instructions that, based on execution by at least one computing device, configure the at least one computing device to perform actions comprising: receiving, by the at least one computing device, a request to identify a relevant owner of a identified target component; calculating, for each contributor of a plurality of contributors to the identified target component by a calculated benchmark ranking (“CBR”) calculator of the at least one computing device, a CBR; selecting, by an owner tracker controller of the at least one computing device based at least in part on the CBRs, an area path (“AP”) that is owned by a contributor of the each contributors, where the selected AP is in an AP hierarchy that corresponds to the identified target component; mapping, by the owner tracker controller, the selected AP to a current AP; and identifying, by the owner tracker controller based on the current AP, the relevant owner for the identified target component.

In the first, second, and third examples, the identified target component is a source file; and/or each of the CBRs is a weighted value based at least in part on a number of lines of code in the source file touched by the corresponding contributor; and/or each of the CBRs is weighted based on a recency of a touch of the source file by the corresponding contributor; and/or at least one of the examples includes a manager calculated benchmark ranking (“MCBR”) calculator via which the owner tracker calculates, for each manager of the plurality of contributors to the identified target component, a MCBR; and/or the selected AP is further selected based at least in part on the MCBRs.

The detailed description provided in this section, in connection with In view of the many possible embodiments to which the invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A method performed on at least one computing device, the method comprising:
receiving, by the at least one computing device, a request to identify a relevant owner of an identified target component;
calculating, for each contributor of a plurality of contributors to the identified target component by a calculated benchmark ranking (“CBR”) calculator of the at least one computing device, a CBR;
selecting, by an owner tracker controller of the at least one computing device based at least in part on the CBRs, an area path (“AP”) that is owned by a contributor of the each contributors, where the selected AP is in an AP hierarchy that corresponds to the identified target component;
mapping, by the owner tracker controller, the selected AP to a current AP; and
identifying, by the owner tracker controller based on the current AP, the relevant owner for the identified target component.

2. The method of claim 1 where the identified target component is a source file.

3. The method of claim 2 where each of the CBRs is a weighted value based at least in part on a number of lines of code in the source file touched by the corresponding contributor.

4. The method of claim 3 where each of the CBRs is weighted based on a recency of a touch of the source file by the corresponding contributor.

5. The method of claim 1 further comprising calculating, for each manager of the plurality of contributors to the identified target component by a manager calculated benchmark ranking (“MCBR”) calculator of the at least one computing device, a MCBR.

6. The method of claim 5 where the selected AP is further selected based at least in part on the MCBRs.

7. The method of claim 5 where each of the MCBRs is based on a sum of the CBRs of the corresponding manager's direct report contributors of the plurality of contributors.

8. At least one computing device comprising:
at least one processor;
memory coupled to the at least one processor;
an owner tracker via which the at least one computing device receives a request to identify a relevant owner for a target component;
a calculated benchmark ranking (“CBR”) calculator via which the owner tracker calculates, for each contributor on a list of contributors to the identified target component, a CBR;
an owner tracker controller via which the owner tracker selects, based at least in part on the CBRs, an area path (“AP”) that is owned by a contributor of the each contributors, where the selected AP is in an AP hierarchy that corresponds to the identified target component;
the owner tracker controller via which the owner tracker maps the selected AP to a current AP; and
the owner tracker controller via which the owner tracker identifies, based on the current AP, the relevant owner for the identified target component.

9. The at least one computing device of claim 8 where the identified target component is a source file.

10. The at least one computing device of claim 9 where each of the CBRs is a weighted value based at least in part on a number of lines of code in the source file touched by the corresponding contributor.

11. The at least one computing device of claim 10 where each of the CBRs is weighted based on a recency of a touch of the source file by the corresponding contributor.

12. The at least one computing device of claim 8 further comprising a manager calculated benchmark ranking (“MCBR”) calculator via which the owner tracker calculates, for each manager of the plurality of contributors to the identified target component, a MCBR.

13. The at least one computing device of claim 12 where the selected AP is further selected based at least in part on the MCBRs.

14. The at least one computing device of claim 12 where each of the MCBRs is based on a sum of the CBRs of the corresponding manager's direct report contributors of the plurality of contributors.

15. At least one computer-readable medium that comprises computer-executable instructions that, based on execution by at least one computing device, configure the at least one computing device to perform actions comprising:
receiving, by the at least one computing device, a request to identify a relevant owner of a identified target component;
calculating, for each contributor of a plurality of contributors to the identified target component by a calculated benchmark ranking (“CBR”) calculator of the at least one computing device, a CBR;
selecting, by an owner tracker controller of the at least one computing device based at least in part on the CBRs, an area path (“AP”) that is owned by a contributor of the each contributors, where the selected AP is in an AP hierarchy that corresponds to the identified target component;
mapping, by the owner tracker controller, the selected AP to a current AP; and
identifying, by the owner tracker controller based on the current AP, the relevant owner for the identified target component.

16. The at least one computer-readable medium of claim 15 where the identified target component is a source file.

17. The at least one computer-readable medium of claim 16 where each of the CBRs is a weighted value based at least in part on a number of lines of code in the source file touched by the corresponding contributor.

18. The at least one computer-readable medium of claim 17 where each of the CBRs is weighted based on a recency of a touch of the source file by the corresponding contributor.

19. The at least one computer-readable medium of claim 15, the actions further comprising calculating, for each manager of the plurality of contributors to the identified target component by a manager calculated benchmark ranking (“MCBR”) calculator of the at least one computing device, a MCBR.

20. The at least one computer-readable medium of claim 19 where the selected AP is further selected based at least in part on the MCBRs, or where each of the MCBRs is based on a sum of the CBRs of the corresponding manager's direct report contributors of the plurality of contributors.
